(19) United States
(12) Patent Application Publication
(10) Pub. No.: US 2004/0204946 A1
(43) Pub. Date: Oct. 14, 2004

(54) Merchant branded software

(76) Inventors: Jeffrey H. Alger, Redmond, WA (US); Clifford Owen Guren, Sammamish, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(21) Appl. No.: 09/859,565

(22) Filed: May 16, 2001

(51) Int. Cl. G06F 17/60; G06F 9/44

(52) U.S. Cl. 705/1; 705/26

(57) ABSTRACT

Branded software and a method of branding software where the software includes core data that is distributed through different merchants. Additional branding data, specific to a particular merchant, is added to the core data in order to brand the core data for that merchant. The branding data may be integrated into the core data such that it cannot be deleted or replaced without damaging the execution or display of the core data. The branding data may be added by the software's publisher before distribution to the different merchants, or by each merchant after receiving the software from the publisher.

### TECHNICAL FIELD

The present invention relates to associating information with software. More particularly, the present invention relates to branding software so that the software will evoke an association with a particular entity, such as a merchant, when the software is used.

### BACKGROUND OF THE INVENTION

In the past twenty years, software has become a major component of the world economy. Consumers use it in every aspect of their lives, from purchasing groceries to organizing their finances. Moreover, consumers purchase and use a wide variety of software programs. Application software, for example, may perform one or more specific functions, such as word processing, sending and receiving electronic messages, or playing music. Content software (e.g., electronic books), on the other hand, may only convey information, such as text, audio or graphic images. Still further, operating system software may control the operation of a computer to employ application software or to render content software.

While software is a relatively new innovation for consumers, branding has long been a useful tool for both consumers and merchants. Branding allows a merchant to distinguish its goods from other merchants selling similar or identical goods. Moreover, branding allows a consumer to readily identify a merchant that the consumer has had past favorable experience with and can trust. A merchant can brand its goods in a variety of ways. For example, a merchant can emphasize a particular name or mark (i.e., a trademark) with the sale of its goods, so that the mark evokes in the consumer an association with that merchant. Alternately, a merchant may modify the look and/or feel of the goods (or its packaging) so that the very use of the goods themselves evokes an association with the merchant.

Even through branding provides a proven benefit to both merchants and consumers, it has been difficult for merchants to effectively brand software. Software is typically created by a publisher that actually writes the software code for resale by a number of different merchants. Thus, individual merchants are unable to distinguish their software products from those offered by other merchants since they are all selling literally the exact same product. A merchant can advertise its brand over the media (for example, by television, radio or newspaper advertisements), but this may be prohibitively expensive, particularly for smaller merchants. If a consumer purchases software from a merchant's brick and mortar building, then the merchant can provide branding information or other differentiating services to the consumer while he or she is in the building, but the consumer will usually dispose of any branding information (e.g., a box label, written materials, etc.) soon after leaving the building. A consumer may not even remember where he or she purchased software only a few months after the purchase.

Consumers are now using the Internet to purchase software for delivery through the mail or by download directly through the Internet. While these methods for obtaining software are very convenient for the consumer, they make the merchant's task of differentiating itself from its competition even more difficult. The consumer may be exposed to branding information at a merchant's Internet Web site for only a few minutes before completing the purchase or initiating the download. This is not sufficient time for a merchant to differentiate itself by establishing brand recognition with the consumer. Further, search engines that now allow a consumer to locate a merchant selling a particular software item that are oblivious to the merchant's brand reputation. This reduces the consumer's need to rely on brand information to locate a merchant.

Ironically, despite the added difficulty in branding software purchased over the Internet, branding is particularly important to those merchants doing business over the Internet. Whereas brick and mortar stores have many opportunities to differentiate themselves through various services, e.g. physical location, available parking, hours of operation, available and educated staff, and comfortable and safe surroundings, on-line merchants are very limited in their opportunities to differentiate themselves from their competitors. Typically, these merchants are relatively new, and have not yet had an opportunity to establish a significant reputation with consumers. Moreover, the consumer is buying the software at arm's length from the merchant, and has only a merchant's reputation to judge the reliability or honesty of that merchant.

### SUMMARY OF THE INVENTION

The present invention conveniently allows a merchant to differentiate the software it provides to its customers in a number of different ways, so that the use of the software is certain to evoke an association with that merchant. With the invention, software can be branded so that rendering its image (e.g., its text or graphic content or its user interface) evokes an association with the merchant. Software can also be branded so that its very operation evokes an association with the merchant. Further, according to the invention, software may be branded so that its functionality evokes an association with the merchant.

The invention involves a core software program that may be individually branded by or for a number of different merchants. According to the invention, the core software may be branded by each merchant prior to sale, or by the publisher before distribution to the merchant. Further, the publisher may conveniently brand the core software with branding information for a number of different merchants, and each merchant may then delete or deactivate the extraneous branding information. Still further, branding information from the merchant and the core software from the publisher may be combined at the consumer's computer. Each of these branding configurations and techniques will be discussed in detail below.

### BRIEF DESCRIPTION OF THE DRAWINGS

FIG. 1 schematically illustrates a possible computing platform for implementing various embodiments of the invention.

FIG. 2 schematically illustrates the structure of a software program that has branding information in accordance with embodiments of the present invention.

FIG. 3 illustrates an example of the implementation of appearance branding data and operational branding data according to embodiments of the present invention.

FIG. 4 illustrates an example of the implementation of functionality branding data according to embodiments of the present invention.

FIGS. 5A-5E show various methods by which branding data may be incorporated into software in accordance with embodiments of the present invention.

### DETAILED DESCRIPTION OF THE INVENTION

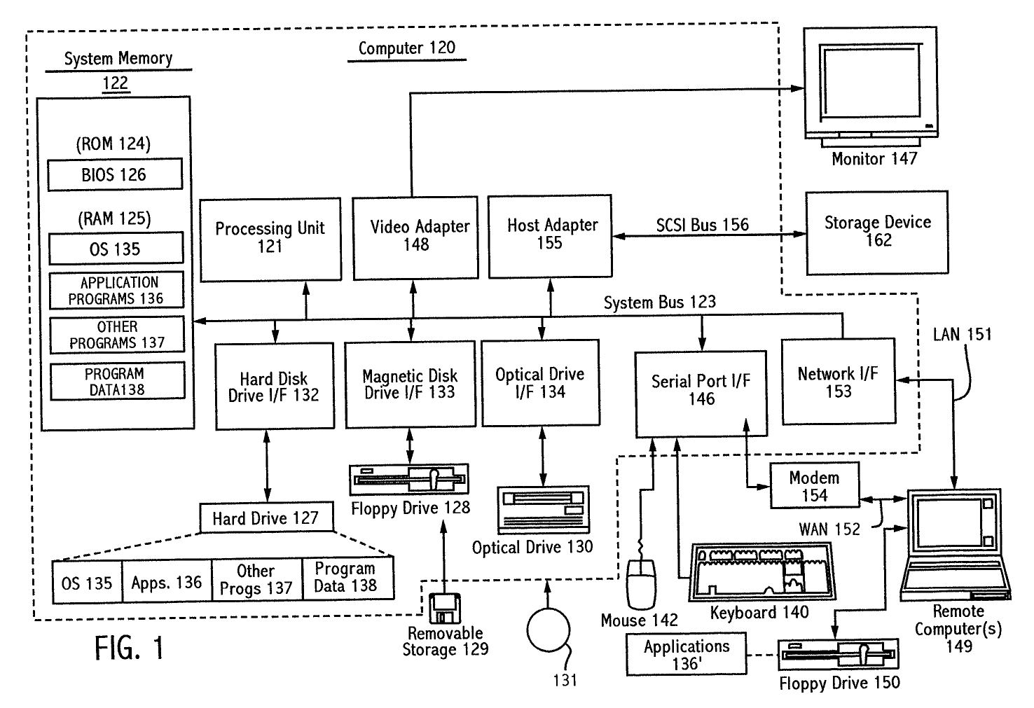

As is well known in the art, software is implemented on computers. FIG. 1 shows a computer system for creating, retrieving and/or implementing branded software according the invention. The system includes a general purpose computing device in the form of a conventional personal computer or network server 120 or the like, including a processing unit 121, a system memory 122, and a system bus 123 that couples various system components including the system memory 122 to the processing unit 121. The system bus 123 may be any of several types of bus structures including a memory bus or memory controller, a peripheral bus, and a local bus using any of a variety of bus architectures. The system memory includes read-only memory (ROM) 124 and random access memory (RAM) 125. A basic input/output system 126 (BIOS), containing the basic routines that help to transfer information between elements within the personal computer 120, such as during startup, is stored in ROM 124.

The personal computer or network server 120 may further include a hard disk drive 127 for reading from and writing to a hard disk (not shown), a magnetic disk drive 128 for reading from or writing to a removable magnetic disk 129, and an optical disk drive 130 for reading from or writing to a removable optical disk 131 such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide non-volatile storage of computer readable instructions, data structures, program modules and other data for the personal computer or network server 120. Although the environment described herein employs a hard disk, a removable magnetic disk 129 and a removable optical disk 131, it should be appreciated by those skilled in the art that other types of computer readable media which may store data that is accessible by a computer, such as magnetic cassettes, flash memory cards, digital video disks, Bernoulli cartridges, random access memories (RAMs), read-only memories (ROMs) and the like may also be used in the operating environment.

A number of program modules may be stored on the hard disk 127, magnetic disk 129, optical disk 131, ROM 124 or RAM 125, including an operating system 135 (e.g., Windows® 2000, Windows NT®, or Windows 95/98), one or more application programs 136, other program modules 137 and program data 138. A user may enter commands and information into the personal computer 120 through input devices such as a keyboard 140 and pointing device 142. Other input devices (not shown) may include a microphone, joystick, game pad, satellite disk, scanner or the like. These and other input devices are often connected to the processing unit 121 through a serial port interface 146 that is coupled to the system bus 123, but may be connected by other interfaces, such as a parallel port, game port, universal serial bus (USB), or a 1394 high-speed serial port. A monitor 147 or other type of display device is also connected to the system bus 123 via an interface, such as a video adapter 148. In addition to the monitor 147, personal computers typically include other peripheral output devices (not shown), such as speakers and printers. Further, other storage devices represented collectively by storage device 162 may be connected to the personal computer or network server 120 through a SCSI interface represented by SCSI bus 156, which is connected to the system bus 123 through host adaptor 155.

The personal computer or network server 120 may operate in a networked environment using logical connections to one or more remote computers, such as a remote computer 149. The remote computer 149 may be another personal computer, another network server, a router, a network PC, a peer device or other common network node, and typically includes many or all of the elements described above relative to the personal computer 120, although only a memory storage device 150 with applications 136′ has been illustrated in FIG. 1. The logical connections depicted in FIG. 1 include a local area network (LAN) 151 and a wide area network (WAN) 152. Such networking environments are commonplace in offices, enterprise-wide computer networks, Intranets and the Internet.

When used in a LAN networking environment, the personal computer or network server 120 is connected to the local network 151 through a network interface or adapter 153. When used in a WAN networking environment, the personal computer or network server 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer or network server 120, or portions thereof, may be stored in the remote memory storage device 150. It will be appreciated that the network connections shown are exemplary and other means of establishing a communications link between the computers may be used.

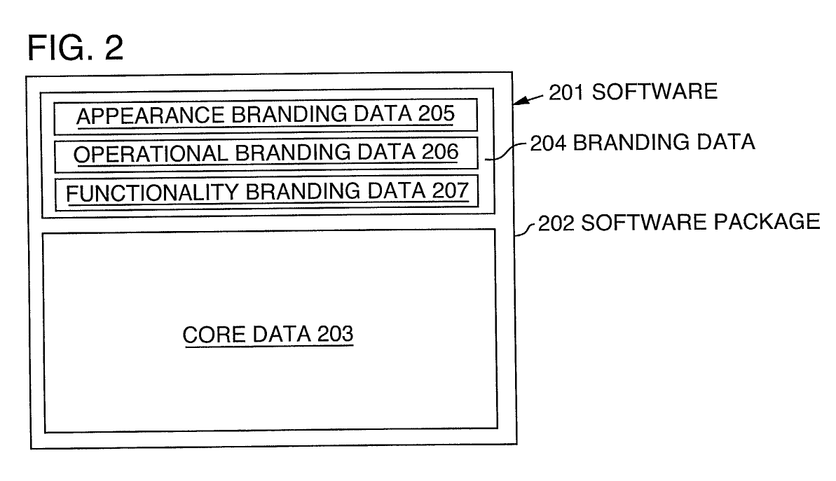

One embodiment of software according to the invention is shown in FIG. 2. As seen in this figure, the software 201 includes a package 202 containing the core data 203 of the software. The core data 203 is the portion of the software 201 that actually performs the software's primary functions or conveys the software's primary information. For example, if the software 201 is an application, such as a browser (e.g., Microsoft® Internet Explorer), then the core data 203 includes the programming code necessary to perform all of the general functions of the browser. That is, the core data 203 contains the programming code necessary to perform those functions of the browser that are not specific to a particular merchant. Similarly, if the software 201 is content, (e.g., a Web page written in the hypertext markup language (HTML)), then the core data 203 is the actual content to be displayed by a content-rendering software application. Likewise, if the software 201 is an operating system, then the core data 203 contains the programming code necessary to perform all of the general functions of an operating system (i.e., those operating system functions that are not specific to a particular merchant, as will be discussed below).

It should be noted that the software package 202 may be a physical package, such as a compact disc or magnetic diskette. Alternately, the software package 202 may be a virtual package, such as that represented by the initial data and final data provided during a download of the software 201 over the Internet. In any case, the package 202 is simply the boundary that defines the integration of the software's components into a single functioning unit.

According to the invention, the software package 202 also encompasses branding data or information 204. The branding data 204 is data that is added to the software package 201 to evoke an association with a particular merchant when the software 201 is used. As will be explained in detail below, the branding data 204 may be added to the software package 201 by the publisher of the core data 203, by the merchant itself, or by the consumer's computer before or as the software 201 is used or viewed by the consumer. The branding data 204 may include one or more of several different types of branding data, such as appearance branding data 205, operational branding data 206, and/or functionality branding data 207.

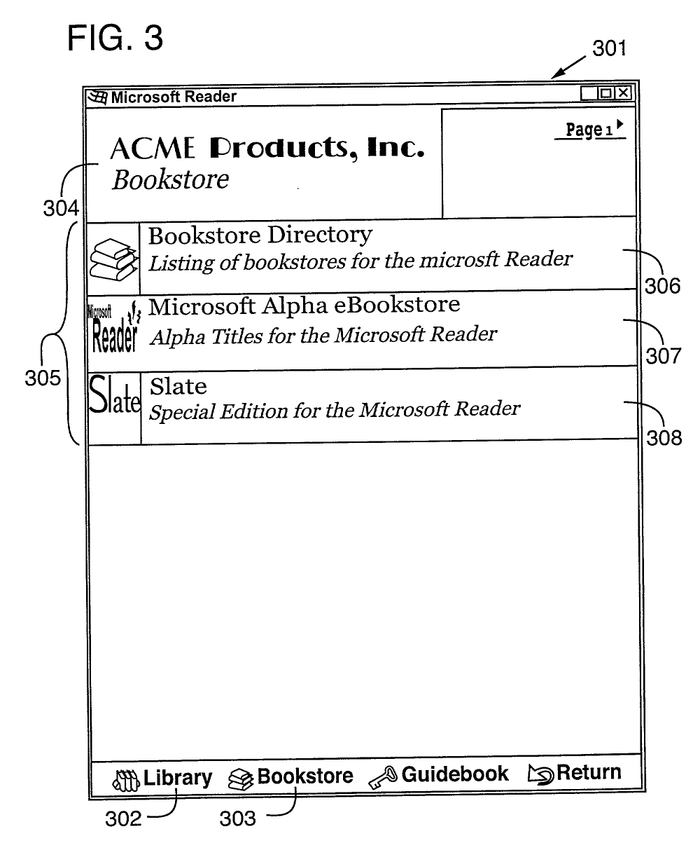

Appearance branding data 205 is data that, when implemented, provides the software 201 with a particular appearance that evokes an association with a specific merchant. For example, appearance branding data 205 may operate to cause the software 201 to display an image of the merchant's name or trademark in the software's user interface or information content. One example of the implementation of appearance branding data 205 is illustrated in FIG. 3.

This figure shows one possible graphic user interface 301 for the Microsoft Reader, a special purpose browser for retrieving and displaying electronic books. As is known in the art, this interface 301 has various commands relating to the primary functions of the Reader (i.e., the functions implemented by the core data 203). For example, the interface 301 provides a button 302 labeled “library” for instructing the browser to display a list of electronic books or other contents stored in the user's system memory for viewing with the Reader, and a button 303 labeled “bookstore” for instructing the browser to display a list of bookstore sites accessible to the Reader. In should be noted that both the library site and the bookstore site may be stored in the browser's memory or alternately be located at a remote server computer in a network.

As seen in FIG. 3, the graphic user interface 301 also includes an appearance-branding image 304. The appearance-branding image 304 is created by the appearance branding data 205 included in the software package 202. In the illustrated example, the appearance-branding image 304 displays the name of a specific merchant (i.e., ACME Bookstore). Those of ordinary skill in the art, however, will appreciate that any appearance feature may be used to evoke an association with a particular merchant. For example, the appearance branding data 205 may cause the software 201 to additionally or alternately display a merchant's trademark. The appearance branding data 205 may also, for example, determine a distinct overall color scheme for the user interface 301 in order to evoke an association with a merchant. In the present example of the Microsoft Reader application, appearance branding 304 appears on the Reader's user interface, regardless of whether or not the computer, on which the Reader application is executing, is connected to the Internet.

Returning now to FIG. 2, the branding data 204 may alternately, or additionally, include operational branding data 206. Operational branding data 206 is data that controls the very operation of the software 201 so as to cause it to evoke an association with a particular merchant. As will be explained below, one example of the implementation of operational branding data 206 is also shown in FIG. 3.

As may be seen from this figure, the core data 203 does not provide the user interface 301 of the Reader with the “address line” found in conventional browsers. The user thus cannot readily type in specific Internet addresses for the browser to access. Instead, the Reader only accesses those Internet addresses that are previously stored in the Reader's memory or obtained through an Internet address previously stored in the Reader's memory. The interface 301 therefore includes a list 305 of different sites 306-308 accessible to the Reader. To access one of these listed sites, the user activates the site listing by, for example, moving a displayed cursor over the site listing and then depressing a control button (commonly referred to as “clicking” on the site listing) or otherwise indicating a selection of the site including, but not limited to, tapping the selection with a stylus, hovering over the site listing, double clicking, and other known selection mechanisms.

The Internet addresses accessible to the Reader may be included in the core data 203, in the operational branding data 206, or both. Thus, a merchant can brand the Reader simply by adding operational branding data 206 that includes an Internet address for the merchant's site. The list 305, for example, includes a site listing 308 for a site maintained by the merchant “Slate.” This site listing corresponds to the Internet address for the “Slate” Web site stored in the operational branding data 206 for the Reader. By including its site's Internet address in the operational branding data 206, the merchant “Slate” changes the operation of the Reader so that the Reader's operation evokes an association with that merchant. That is, when a user operates the Reader, the Web site for the merchant “Slate” is one of the only Web sites accessible to the Reader, so the user cannot help but associate the operation of the Reader with the merchant “Slate.”

While the listing of accessible Internet sites in a special purpose browser is one embodiment of operational branding data 206, those of ordinary skill in the art will appreciate that a wide variety of operational branding data 206 is encompassed by the invention. Yet another embodiment of this invention may be implemented, for example, with network search engines, such as those used by colleges, universities and research laboratories to conduct technical research over a variety of associated networked libraries. With this embodiment, the software 201 for the search engine may include core data 203 that performs all of the primary functions of a conventional search engine. Identical versions of the core data 203 may then be distributed to a number of different institutions. A version of the search engine software 201 licensed to a particular university (e.g., the University of Virginia), however, might then further include operational branding data 206 that would allow that particular version of the search engine software 201 to access libraries unavailable to versions of the search engine employed by other colleges and universities. For example, the operational branding data 206 might include password or token information for accessing restricted proprietary libraries. Thus, the access provided by using that particular version of the software 201 would evoke an association with the institution to which it was licensed and, thus, provides value to both the user and the institution. The user achieves access to otherwise restricted information or sites, and the institution becomes “sticky” in that the institution becomes associated with the ability to access information and that the user needs to return to the institution (or at least the tools provided by the institution) to regain access to the information or sites. Further, by monitoring the activities of the user when accessing the information or site, the institution may personalize offers to the user that are particular or complementary to the locations accessed. The institution may monitor the activities of the user through cookies and other known user monitoring systems.

Still other embodiments of the invention will be apparent to those of ordinary skill in the art. For example, the operational branding data 206 may include data that allows an application to read or store files in a specific file type that is associated with a merchant, data that prohibits a browser from accessing sites maintained by a merchant's competitors, data that causes a browser to automatically employ a particular merchant's credit card for purchases via the browser, etc. It is appreciated that the Microsoft® Reader is just one example of brandable software. The software that may be branded as disclosed in this specification is expansive and includes the following examples: full-function web browsers (Opera, Netscape, Internet Explorer, and the like), word processing software, spreadsheet programs, database programs, authoring tools (web-based and non-web based), operating systems, and the like.

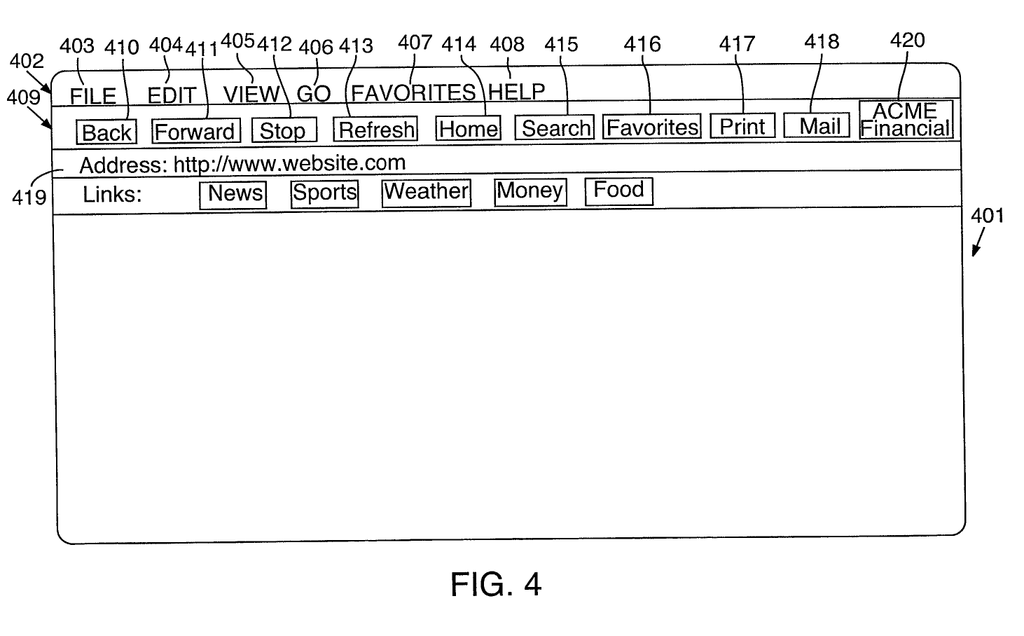

Turning back now to FIG. 2, the branding data 204 may also (or alternately) include functionality branding data 207. This is data that modifies the software to include a function specific to a particular merchant. One possible implementation of such functionality branding data is shown in FIG. 4. This figure illustrates a graphic user interface 401 for a generic browser. As is known in the art, this interface 401 includes a first task bar 402 with conventional command buttons 403-408 entitled “File,” “Edit,” “View,” “Go,” “Favorites,” and “Help,” respectively. The interface 401 also includes a task bar 409 with conventional command buttons 410-418, entitled “Back,” “Forward,” “Stop,” “Refresh,” “Home,” “Search,” “Favorites,” “Print,” and “Mail,” respectively, and an address line 419 where a user may enter a page to be retrieved by the browser.

In addition to these conventional command buttons 403-408 and 410-418, the task bar 409 also includes a branding command button 420, entitled “ACME Financial.” The branding command button 420 is provided by the functionality branding data 207, and instructs the browser to perform a function corresponding specifically to a particular merchant (such as ACME Financial in the illustrated embodiment) so as to evoke an association with that merchant. For example, with the illustrated merchant, the command button 420 may instruct the browser to retrieve or purchase investment data from a previously determined site maintained by that particular merchant, and then download the retrieved investment data to financial planning software on the browser's computer, such as Microsoft Money. Alternately, the branding command button 420 may instruct financial planning software on the browser's computer to send financial information through the browser to a site maintained by that merchant.

By including functionality branding data 207 that adds merchant-specific functions to the generic functions of a conventional browser functions, the merchant may brand the browser so that its use evokes an association with the merchant. As will be appreciated by those of ordinary skill in the art, while the illustrated embodiment relates to a browser, functionality branding data 207 may be employed to brand a wide variety of software. Further, functionality branding data 207 may be used to provide a wide variety of functions that may be associated with a specific merchant.

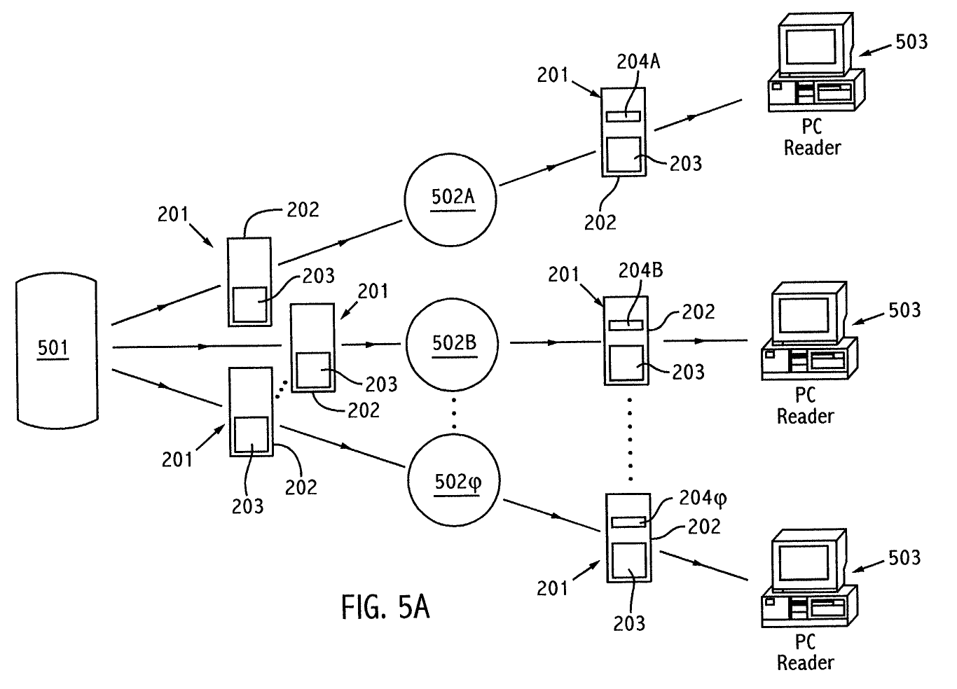

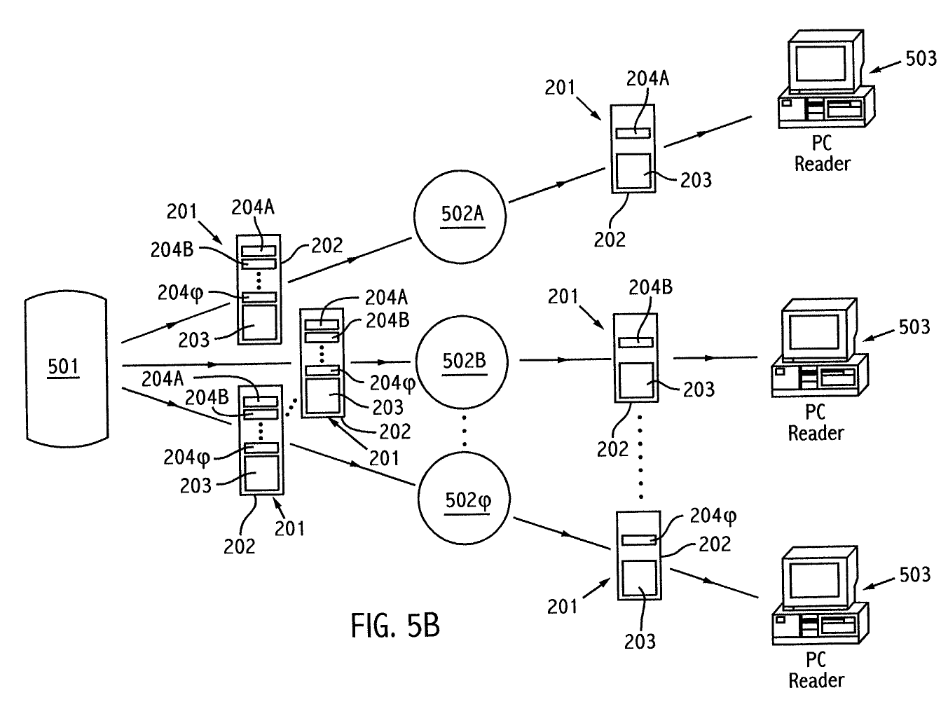

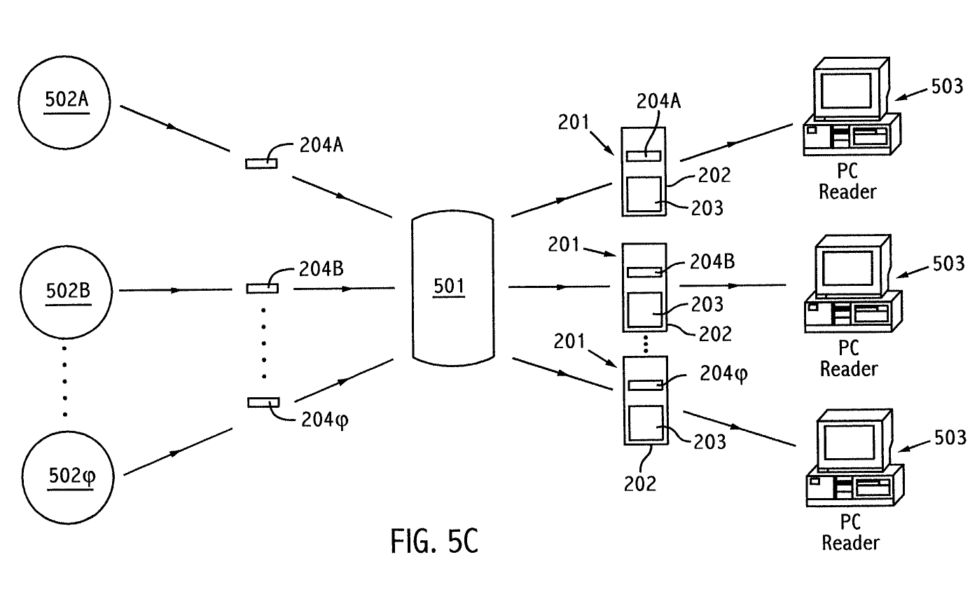

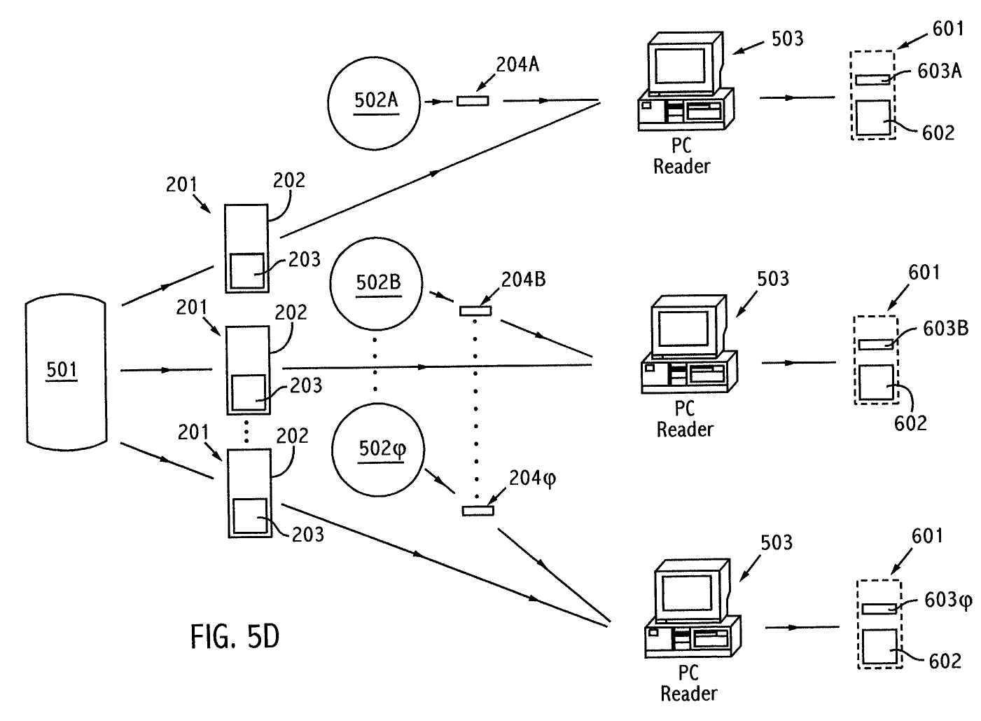

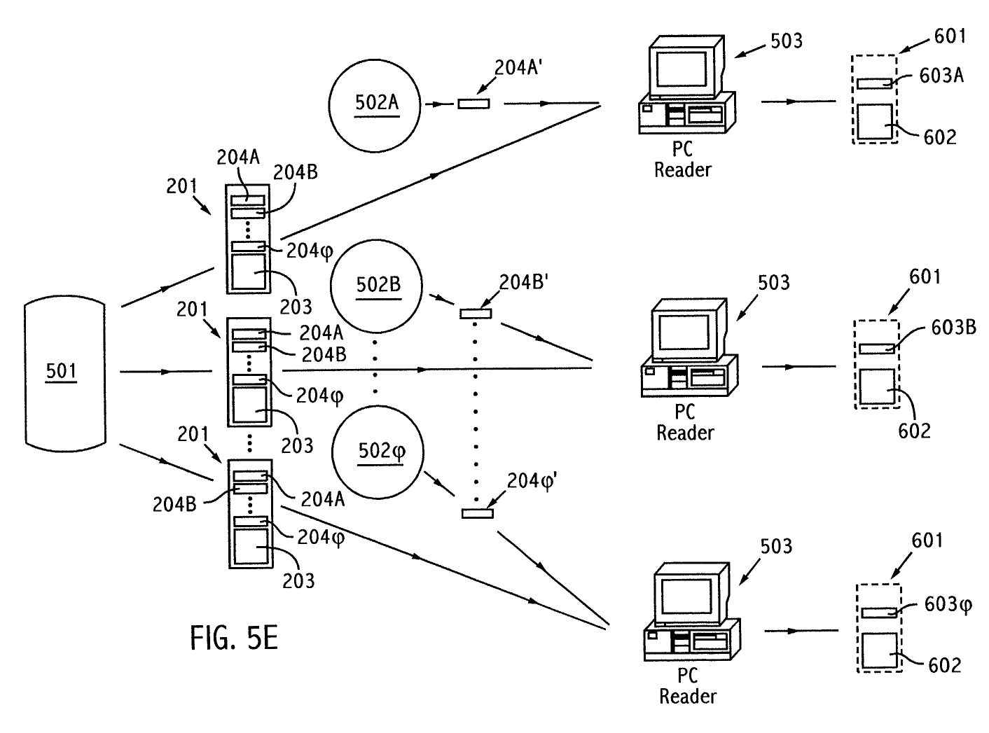

Various methods by which branding data 204 may be incorporated into the software 201 will now be discussed with reference to FIGS. 5A-5E. As shown in FIG. 5A, a software publisher 501 produces a number of copies of the software 201. These copies include the software package 202 and the core data 203, but do not have any branding information 204. The publisher 501 provides an unbranded copy of the software 201 to each of merchants 502A-502φ. Each merchant 502A-502φ receives the software 201 and adds its branding information 204 to its copy of the software 201. For example, merchant 502A adds branding information 204A corresponding to itself to its copy of the software 201. Similarly, merchant 502B adds branding information 204B for itself to its copy of the software 201, merchant 502φ adds branding information 204φ for itself to its copy of the software 201, and so on. Each merchant then distributes (e.g., sells) its branded version of the software 201 to a consumer 503. This technique is particularly beneficial where the consumer 503 purchases the finished software product 201 directly from the merchant 502. Further, it allows each merchant 502 to update its branding data 204 as often as desired, without having to go to the publisher 501 to make the update. Alternatively, each merchant 502A-502φ may also include other branding information with each software application. This may be used when some of the merchants have partnered or are offering products or services in combination with other merchants.

One alternative to the method of FIG. 5A is shown in FIG. 5B. As shown in this figure, the software publisher 501 again publishes several copies of the software 201 with the core data 203. Unlike the previous method, however, the publisher 501 also includes branding information 204A-204φ for each participating merchant 502A-502φ with each of the copies of software 201. That is, each copy of the software 201 includes branding information 204A-204φ for every merchant 502A-502φ. After receiving the software 201, each merchant 502 then deactivates or deletes the branding data for the other merchants 502. For example, the merchant 502A deletes or deactivates all of the branding data 204 except for branding data 204A (i.e., deletes branding data 204B-204φ before distributing the software 201 to the consumer 503. Likewise, merchant 502B deletes or deactivates all of the branding data 204 except for branding data 204B, while merchant 502φ deletes or deactivates all of the branding data 204 except for branding data 204φ.

In another embodiment of FIG. 5B, merchants 502A-502P may leave intact multiple other brandings instead of deleting or disabling all but one of the brandings associated with the software application 201. For example, merchant 502A may partner with merchant 502B in which both offer each other's brands at their store or site. So, the only branding that may be disabled or deleted from the software application 201 may be the branding associated with merchant 502φ. This ability to selectively disable or delete the brandings of other merchants may be used to facilitate partnerships in the marketplace as well as promote a merchant's products or services in a variety of venues. In this regard, merchants 502A and 502B may be in competing businesses (both selling books on-line, for example) or in non-competing businesses (selling books on-line and selling consulting services).

As will be appreciated by those of ordinary skill in the art, with this embodiment each participating merchant 502A-502φ provides its branding data 204 to the publisher 501 before the publisher 501 publishes the software 201. As with the previously described method, this method is also useful where the consumer 503 purchases the finished software product 201 directly from the merchant 502. By allowing the publisher 501 to view and/or modify the branding information 204 before publishing the software 201, however, this method may permit the publisher 501 to better integrate the branding information 204 into the software 501. For example, instead of adding a button or menu to a task bar, the publisher 501 may provide a separately tailored user interface using specific colors and combinations of colors, fonts, text rotations, watermarks, graphics, and any other items that relate the branded goods to the participating merchant (502A-502φ).

Yet another method of integrating branding data 204 into a software program 201 according to the invention is illustrated in FIG. 5C. It should be noted that, with this method, the consumers may 503 obtain their copies of the software 201 directly from the publisher 501 rather than from the merchant 502. For example, a merchant 502A may provide an Internet site that links the consumer 503 directly to the software publisher 501 for purchasing the software 201, possibly without the consumer 503 ever realizing that he or she is not receiving the software 201 from the merchant 502A. With these indirect sales arrangements, the merchant 502A might still like to obtain the consumer's goodwill from the sale by attaching its own branding information 204A to the software 301, so that the consumer's use of the software 201 will evoke an association with the merchant 502A. In another embodiment, the publisher may combine various brandings 204A, 204B, and 204φ together and transmit the combined brandings to the end users 503.

Like the embodiment shown in FIG. 5B, with the embodiment illustrated in FIG. 5C each merchant 502A-502φ provides its branding information 204 to the publisher 501 before the software 201 is published. The publisher 201 then publishes several different versions of the software 201A-201φ, each version having branding information 204 corresponding to a participating merchant 502A-502φ. When a consumer 503 orders the software 201 through a merchant 502, the publisher 501 determines through which merchant 502 the software 201 is being purchased, and provides the consumer 503 with a version of the software 201 branded for that merchant 502.

For example, if a consumer 503 goes to purchase the software 201 from the merchant 502φ, the merchant 502φ may channel the consumer 503 to the publisher 501 through a reference link, such as a HTML link, that the merchant 502φ maintains to the publisher 501. The publisher 501 can determine that the consumer 503 is purchasing the software 201 through the link maintained by the merchant 502φ, and accordingly provide the consumer 503 with a version of the software 201 containing the branding data 204φ corresponding to the merchant 502φ. Alternately, the merchant 502B may provide the consumer 503 with coded information indicating that the consumer 503 has purchased the software 201 from merchant 502B (for instance, cookies, tokens, or passwords). When the consumer 503 then goes to retrieve the purchased software 201 from the publisher 501, the publisher 501 may require the consumer 503 to provide the coded information to complete the transaction. The publisher 501 then recognizes that the coded information is from the merchant 502B, and provides the consumer 503 with a version of the software 201 that has the branding data 204B corresponding to the merchant 502B.

Still another embodiment of the invention is illustrated in FIG. 5D. As with the previously described embodiment, with this embodiment the consumer 503 may obtain the software 201 directly from the publisher 501 rather than from a merchant 502. With this embodiment, however, the publisher 501 publishes a number of copies of the software 201 that do not contain any branding data 204. These generic versions of the software 201 are then delivered to each consumer 503, still without branding data 204. Each merchant 502 then sends its own branding data 204 to the consumer 503 separately. After the consumer's computer receives both the generic software 201 and the branding data 204 from the appropriate merchant 502, the software 201 can employ the branding data 204 to ensure that the software 201, when used by the consumer 503, evokes an association with that merchant 502. That is, when the consumer uses the software 201, it produces the implementation 601 of the software 201 including both the implementation 602 of the core data 203 and the implementation 603 of the branding data 204.

For example, if a consumer 503 purchases the software 201 through merchant 502B, the merchant 502B may provide the consumer 503 with coded information indicating that the consumer 503 has purchased the software 201. The consumer 503 may then provide this coded information to the publisher 501 to receive the generic software 201. The merchant 502B (or alternatively, the publisher 501 or an authorized third party) may also deliver the branding information 204B to the consumer 503. After the generic software 201 has been installed on the consumer's computer, the software 201 will then locate and use the branding information 204B so that the use of the software 201 evokes an association with the merchant 502B.

It should be noted that, with this embodiment of the invention, the merchant need not be involved in the sale of the software 201. The consumer 503 may instead obtain generic software 503 directly from the publisher 501, or from another merchant 502. When the consumer 503 first activates the software 201, the consumer 503 may then select a specific merchant 502 to be associated with the software 201. For example, if the software 201 is the Microsoft Reader, upon activation the Reader may initially provide the consumer 503 with a list of merchants 502A-502φ that provide ebooks compatible with the Reader. The consumer 503 may then select one of the merchants 502A-502φ from which to purchase ebooks for the Reader. If the consumer 503 selects, e.g., merchant 502B, then the Reader may retrieve branding data 204B specifically associated with that merchant 502B. The branding data 204B may be retrieved from the merchant 204B itself, from the publisher, or even from a third party authorized to provide the branding data 204B. After retrieving the branding data 204B, the software 201 would then use the branding data 204B so as to evoke an association with the merchant 204B during future use.

In another embodiment of FIG. 5D, the publisher associates at least some branding information with the software application 201. Here, the initial branding information is supplemented with additional branding information from merchants 502A-502φ (directly or indirectly (e.g., through another merchant)). In short, this embodiment permits merchants to supplement additional branding content to the purchased application. The supplementing process may happen only once (for example, when the user registers the purchased software 201) or may happen over time. For example, the merchant may update the branding information once every month or quarter or in conjunction with other marketing events.

Still another embodiment of the invention is illustrated in FIG. 5E. This embodiment is similar to the previous embodiment in that the publisher 501 provides the same version of the software 201 directly to each of the consumers 503. In this embodiment, however, the software 201 contains branding data 204A-204φ for each participating merchant 502. After purchasing the software 201 through a merchant 502, the consumer 503 receives deactivation (or deletion) information 204′ from that merchant 502 to deactivate (or delete) at least some of the branding information 204 except for the branding information relating to that merchant 502. The merchant 502 may likewise permit other brandings to remain and only deactivate or delete specific brandings. For example, if the consumer 503 purchases the software 201 through merchant 502A, the merchant 502A provides the consumer 503 with coded information confirming his or her purchase, and the consumer 503 then provides this coded information to the publisher 501 to receive the software 201. The merchant 502A also delivers the deactivation (or deletion) information 204A′ to the consumer 503. After the generic software 201 has been retrieved by the consumer's computer, the deactivation (or deletion) information 204A′ will locate and deactivate (or delete) all of the branding information 204 in the software 201, except for the branding data 204A. Thus, the use of the software 201 will evoke an association with the merchant 502A. Alternatively, some other branding information (not from merchant 502A) may remain as merchant 502A may be partnering with other merchants (for example, merchant 502B, whose brandings are left associated with application 201.)

As with this previously discussed embodiment, it should be noted that this embodiment may allow the software 201 to be purchased directly from the publisher 501 or from another merchant 502 without the initial involvement of the merchant subsequently branding the software 201.

Using any of the branding techniques described, as well as other techniques according to the invention that will be apparent to those of ordinary skill in the art, a merchant 502 may individually brand the software 201 it sells, so that its consumer 503 will associate the use of the software 201 with that particular merchant 502. Moreover, each merchant 502 may brand the software 201 in any way it desires, such as with appearance branding data 205, operational branding data 206, functionality branding data 207, or any combination of the three.

Those of ordinary skill in the art will appreciate that the branding data 204 may be integrated with the operation of the core data 203 in a number of ways. For example, the core data 203 may include programming code that checks a previously designated memory location for appearance branding data 204. The core data 203 may then further include instructions to implement whatever branding data 204 is located in that memory location. With this arrangement, the program 201 may then be branded simply by adding the desired branding data 204 to that previously designated memory location. Further, the branding data 204 may be preferably integrated into the software 201 so that it cannot be subsequently deleted, replaced or modified by another merchant. For example, the branding data 204 may be integrated with the software 201 using encrypted data that cannot be changed by another merchant 502. Numerous such implementations of each of the different types of branding data 204 will be apparent to those of ordinary skill in the art.

It will also be appreciated by those of ordinary skill in the art that the software 201 may include branding data 204 for branding other software programs. For example, as previously mentioned, the branding data 204 may include functionality branding data 207 for branding a browser interface 401 to, e.g., download predetermined financial information from a Web site to a financial management program. While this functionality branding data 207 may be incorporated in the software for the browser, it may additionally or alternately modify the software for the financial management program so as to evoke an association with the merchant when the financial management program is used. Other variations for delivering software branding data 204 will also be apparent to those of ordinary skill in the art.

The present invention has been described above by way of specific embodiments, and the many features and advantages of the present invention are apparent from the written description. Thus, it is intended that the appended claims cover all such features and advantages of the invention. Further, since numerous modifications and changes will readily occur to those skilled in the art, the specification is not intended to limit the invention to the exact construction and operation ad illustrated and described. For example, the invention may include any one or more elements from the apparatus and methods described herein in any combination or subcombination. Accordingly, there are any number of alternative combinations for defining the invention, which incorporate one or more elements from the specification (including the drawings, claims, and summary of the invention) in any combinations or subcombinations. Hence, all suitable modifications and equivalents may be considered as falling within the scope of the appended claims.

What is claimed is:

1. A method for distributing variations of electronic data through multiple merchants to purchasers, comprising the steps of:
publishing a core portion for a first merchant to make available to purchasers as a first variation having a first merchant-specific portion;
publishing a second variation containing the core portion for a second merchant to make available to purchasers as a second variation having a second merchant-specific portion, and
wherein the first merchant-specific portion differing from the second merchant-specific portion so that a purchaser's viewing or execution of the first variation evokes an association with the first merchant and a purchaser's viewing or execution of the second variation evokes an association with the second merchant.

2. The method of distributing variations of electronic data recited in claim 1, wherein
the first merchant adds the first-merchant specific portion to the core portion to produce the first variation,
and the second merchant adds the second-merchant specific portion to the core portion to produce the second variation.

3. The method of distributing variations of electronic data recited in claim 1, wherein
a publisher provides the core portion to the first merchant with both the first-merchant specific portion and the second-merchant specific portion, and
the first merchant enables or deletes at least a part of the second-merchant specific portion to produce the first variation.

4. The method of distributing variations of electronic data recited in claim 1, wherein the core portion includes a program executable by a computer device.

5. The method of distributing variations of electronic data recited in claim 4, wherein the core portion is a rendering application for rendering content, such that the rendering of content using the first variation evokes an association with the first merchant.

6. The method of distributing variations of electronic data recited in claim 4, wherein the core portion is a commerce application for purchasing goods or services, such that the purchase of goods or services using the first variation evokes an association with the first merchant.

7. The method of distributing variations of electronic data recited in claim 6, wherein the core portion is a commerce application for purchasing goods or services from the first merchant.

8. The method of distributing variations of electronic data recited in claim 6, wherein the core portion is a commerce application for purchasing content.

9. The method of distributing variations of electronic data recited in claim 4, wherein the first-merchant specific portion evokes an association with the first merchant by controlling an appearance of the program during execution.

10. The method of distributing variations of electronic data recited in claim 9, wherein the first-merchant specific portion evokes an association with the first merchant by providing a user interface for the program during execution that displays at least one image associated with the first merchant.

11. The method of distributing variations of electronic data recited in claim 4, wherein the first-merchant specific portion evokes an association with the first merchant by controlling one or more functions of the program during execution.

12. The method of distributing variations of electronic data recited in claim 11, wherein the first-merchant specific portion evokes an association with the first merchant by providing added functionality to the program during execution, such that the added functionality relates to the first merchant.

13. The method of distributing variations of electronic data recited in claim 12, wherein the program is a browser application for retrieving content from sites in network.

14. The method of distributing variations of electronic data recited in claim 13, wherein the first-merchant specific portion evokes an association with the first merchant by providing function controls in a user interface for the browser that facilitate the retrieval of content from only sites associated with the first merchant.

15. The method of distributing variations of electronic data recited in claim 13, wherein the first-merchant specific portion evokes an association with the first merchant by providing function controls in a user interface for the browser that facilitate the retrieval of specific content associated with the first merchant.

16. The method of distributing variations of electronic data recited in claim 4, wherein the first-merchant specific portion evokes an association with the first merchant by controlling an operation of the program during execution.

17. The method of distributing variations of electronic data recited in claim 16, wherein the first-merchant specific portion evokes an association with the first merchant by limiting or expanding the operation of the program during execution.

18. The method of distributing variations of electronic data recited in claim 17, wherein the program is a browser application for retrieving content from sites in network.

19. The method of distributing variations of electronic data recited in claim 18, wherein the first-merchant specific portion evokes an association with the first merchant by limiting the operation of the browser to the retrieval of content from only sites associated with the first merchant.

20. The method of distributing variations of electronic data recited in claim 18, wherein the first-merchant specific portion evokes an association with the first merchant by limiting the operation of the browser to the retrieval of specific content associated with the first merchant.

21. The method of distributing variations of electronic data recited in claim 18, wherein the first-merchant specific portion evokes an association with the first merchant by limiting operation of the browser application so that the browser application may retrieve content from designated sites only when the browser application is executing at a physical location defined by the first merchant.

22. The method of distributing variations of electronic data recited in claim 16, wherein the first-merchant specific portion evokes an association with the first merchant by facilitating cooperation between the program and another executable program associated with the first merchant.

23. The method of distributing variations of electronic data recited in claim 1, wherein the core portion is content such that rendering of the first variation evokes an association with the first merchant and rendering of the second variation evokes an association with the second merchant.

24. The method of distributing variations of electronic data recited in claim 1, wherein the first-merchant specific portion is integrated with the core portion such that the first-merchant specific portion cannot be replaced by a portion specific to another merchant without damaging the first variation.

25. The method of distributing variations of electronic data recited in claim 1, wherein the first-merchant specific portion is integrated with the core portion such that the first-merchant specific portion cannot be deleted from the first variation without damaging the first variation.

26. An computer readable medium having stored thereon a data structure, comprising:
a first data field containing core data such that, when executed by a computer, the computer performing one or more functions; and
a second data field containing branding data for modifying the performance of the functions such that the performance of the functions evokes an association with a merchant.

27. The computer readable medium of claim 26, wherein the second data field contains one or more types of data selected from the group consisting of:
appearance branding data for modifying an appearance of the performance of the functions;
operational branding data for modifying the operation of the functions; and
functionality branding data for modifying the performance of the functions.

28. The computer readable medium of claim 26, wherein the second data field contains branding information for a plurality of merchants, such that all of the branding information except for branding information relating to a single merchant must be deleted or deactivated before a computer may properly perform the one or more functions.

29. The computer readable medium of claim 28, wherein the second data field contains one or more types of data selected from the group consisting of:
appearance branding data for modifying an appearance of the performance of the functions;
operational branding data for modifying the operation of the functions; and
functionality branding data for modifying the performance of the functions.

30. A method of selling branded software comprising the steps of:
receiving a software application;
branding said software application;
forwarding said branded software application to a user.

31. The method according to claim 30, wherein said forwarding step includes transmitting said branded software application to said user over the Internet.

32. The method according to claim 30, wherein said forwarding step includes selling said branded software in a store.

33. A method of selling branded software comprising the steps of:
receiving a software application with multiple brandings;
preventing access to at least one of the multiple brandings associated with said software application;
forwarding said branded software application to a user.

34. The method according to claim 33, wherein said forwarding step includes transmitting said branded software application to said user over the Internet.

35. The method according to claim 33, wherein said forwarding step includes selling said branded software in a store.

36. A method of selling branded software comprising the steps of:
receiving a software application;
adding multiple brandings to said software application;
forwarding said branded software application to a user.

37. The method according to claim 36, wherein said forwarding step includes transmitting said branded software application to said user over the Internet.

38. The method according to claim 36, wherein said forwarding step includes selling said branded software in a store.

39. A method of branding software comprising the steps of:
receiving a software application;
adding at least one branding to said software application.

40. The method according to claim 39, wherein said adding step occurs at the software application provider.

41. The method according to claim 39, wherein said adding step occurs at a merchant.

42. The method according to claim 39, wherein said adding step occurs at the location of an end user.

43. A system for branding software comprising:
an input;
a processor; and
an output;
wherein branding information is received from said input and wherein said processor combines said branding information with a software application and forwards said branded application to said output.

44. The system according to claim 43, wherein said processor is associated with an application provider.

45. The system according to claim 43, wherein said processor is associated with a merchant.

46. The system according to claim 43, wherein said processor is associated with an end user.
